(19) United States
(12) Patent Application Publication
(10) Pub. No.: US 2008/0020755 A1
(43) Pub. Date: Jan. 24, 2008

(54) METHOD AND SYSTEM FOR INTERNATIONAL ROAMING USING VIRTUAL SIM CARD

(75) Inventors: Jing Liu, Mountain View, CA (US); Xiaolei Qin, San Jose, CA (US); Bei Du, Beijing (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mino Holdings, Inc., Grand Cayman (KY)

(21) Appl. No.: 11/746,493

(22) Filed: May 9, 2007

Related U.S. Application Data
(60) Provisional application No. 60/801,040, filed on May 16, 2006.
(60) Provisional application No. 60/891,894, filed on Feb. 27, 2007.

(51) Int. Cl. H04Q 7/20; H04M 1/00

(52) U.S. Cl. 455/432.1; 455/558

(57) ABSTRACT

In a cellular telephone environment where SIM cards are used, a single SIM card is provided with a mechanism for supporting conventionally separate services that employ separate SIM cards, such as international calling from various countries, wherein the SIM card is enabled so that the user can dynamically load local SIM information by accessing a remote server (through GPRS/2.5G/3G or by receiving SMS data over the air) and enable the handset to obtain local wireless services.

### CROSS-REFERENCES TO RELATED APPLICATIONS

The present application claims benefit under 35 USC 119(e) of U.S. provisional Application No. 60/801,040, filed on May 16, 2006, entitled “Method And System For International Roaming Using Virtual SIM Card” and U.S. provisional Application No. 60/891,894, filed on Feb. 27, 2007, entitled “Method And System For International Roaming Using Virtual SIM Card,” the contents of which are incorporated herein by reference in its entirety.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to communication or telecommunication. More particularly, the present invention provides a technique, including a method and system, for rendering more portable telephone service in a telecommunication network. As merely an example, the present invention is implemented on a cellular phone network. But it would be recognized that the present invention has a much broader range of applicability.

Telecommunication techniques have been known for ages. Ancient peoples communicated wirelessly over distances by smoke and sound. American Indians communicated to each other over long distances using smoke signals. Smoke signals were generally used to transfer visual information from one geographical location to be observed at another geographical location. Since smoke signals could only be seen over a limited range of geographical distances, they were eventually replaced by a telegraphy. Wired telegraphy transferred information from one geographical location to another geographical location using pulsed electrical signals in the form of “dots” and “dashes” over transmission lines. An example of commonly used cipher is Morse Code. Telegraphy has evolved to include wireless telegraphy, data communications and telephony, supporting point to point voice. Telegraphy has been replaced by telephony for interactive voice telecommunications.

Other types of communication techniques have also been developed. An example of such communication techniques is the wireless cellular telephone network. The cellular network relies upon a short-wave digital or analog telecommunication signals in which a subscriber has a wireless connection from a mobile telephone to a relatively nearby transmitter. The transmitter's span of intended coverage is called a cell. Cellular telephone service is often available in urban areas and along major highways. As the cellular telephone user moves from one cell or area of coverage to another, the telephone is effectively passed on to the local cell transmitter. A newer service similar to cellular is personal communications services (PCS).

Although highly successful and useful, cellular phone services are often limited and expensive. Additionally, cellular phone services are often expensive and difficult to change once the user locks into a particular service for a certain time frequency. Current models for telephone service employ direct charges to the caller, either via an invoice, calling card, credit card or associated charge number. Certain types of telephone services, such as GSM networks, require the use of personalizing plug-ins, called SIM cards (Subscriber Identity Module), that are inserted into cellular telephone handsets and that contain security codes and personal information specific to the service level, individual preferences and data stored by the individual. A Local Area Identification (LAI) is downloaded to the SIM card via the cellular infrastructure to identify the location for the network. A user can swap a SIM card so a new device need not be reregistered on the cellular network when a handset is replaced. However, SIM card technology as presently employed has its limitations. International travelers have been charged with high fees for international roaming calls, both for making calls and for receiving calls. Their alternatives are either to buy a local phone/service, or to buy a local SIM card, since each SIM card is identified by area and user identity. This is very inconvenient and also costly, especially when traveling to many countries. SIM cards can also be duplicated by exploitation of certain characteristic weaknesses in encryption. These and other limitations of conventional cellular phone services are described throughout the present specification and more particularly below.

### BRIEF SUMMARY OF THE INVENTION

According to the invention, a single SIM card is provided with a mechanism for supporting conventionally separate services that employ separate SIM cards, such as international calling from various countries, wherein the SIM card is enabled so that the user can dynamically load local SIM information by accessing a remote server (through GPRS/2.5G/3G or by receiving SMS data over the air) and enable the handset to obtain local wireless services.

(Although outside the scope of this claimed invention, such a server has been described in U.S. patent application Ser. Nos. 11/248,683; filed Oct. 11, 2005; U.S. patent application Ser. No. 11/248,071, filed Oct. 11, 2005 and U.S. patent application Ser. No. 11,248,751, filed Oct. 11, 2005; which all claim priority to U.S. Provisional Application No. 60/618,499; filed Oct. 12, 2004, commonly assigned, and hereby incorporated by reference.) Therefore any incoming or outgoing calls are at local rates, which is much cheaper compared to the same calls using international roaming services. Combined with the single SIM card and compatible roaming service, this invention brings tremendous savings and convenience to international travelers. A method is also provided to implement use of a cellular telephone to make and receive local phone calls in different countries without the roaming charges or replacement of the SIM cards.

These and other features of the invention will be better understood by reference to the following detailed description in connection with the accompanying drawings.

### BRIEF DESCRIPTION OF THE DRAWINGS

FIG. 1 is a schematic diagram of a system supporting a virtual SIM card in a cell phone according to the invention.

FIG. 2 is block diagram of a cell phone with a SIM template management framework according to the invention.

FIG. 3 is a flow chart of one embodiment of a menu driven SIM manager according to the invention.

FIG. 4 is a flow chart for an interactive menu driven SIM template selection process.

FIG. 5 is a flow chart for a SIM template activation process using an SMS command.

FIG. 6 is a flow chart for a SIM template activation process via a GPRS connection.

### DETAILED DESCRIPTION OF THE INVENTION

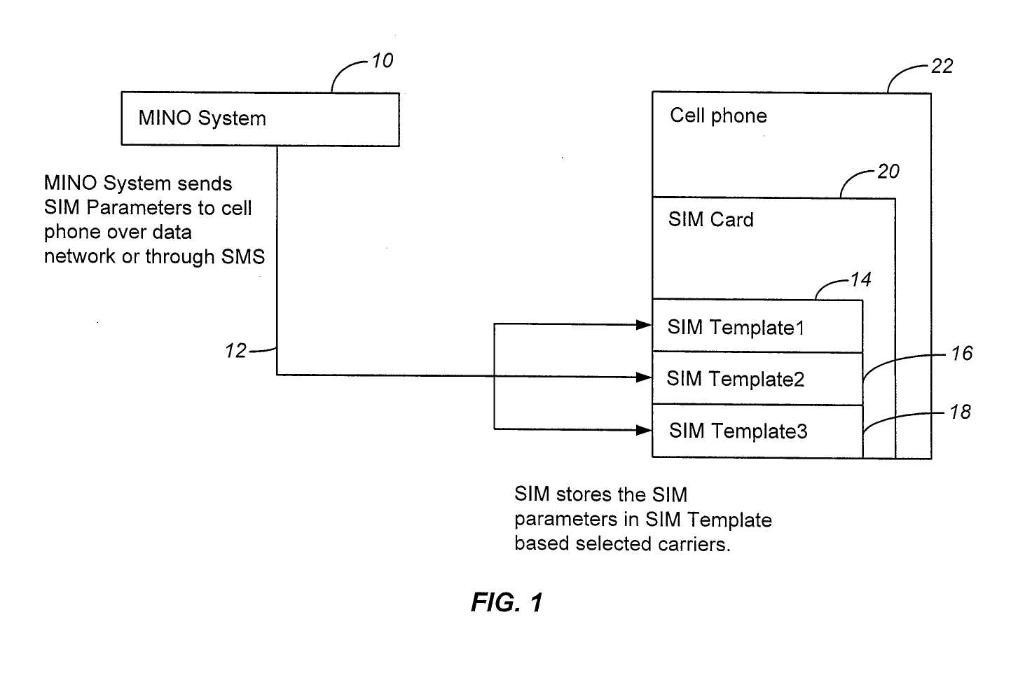

Referring to FIG. 1, a list of carrier data in each country is stored in a central database 10, herein a system controlled by MINO company. When customers choose a list of countries to be visited, they purchase a single SIM card from a website, and thereupon the carrier data associated with those countries to be visited is sent to the customers' telephone in an appropriate form suitable for downloading, such as via SMS or an Internet connection 12. SIM templates 14, 16, 18 are then created on the SIM card 20 in the software of the cellular telephone 22 for each carrier, and the carrier data is stored in the corresponding SIM template. When customers travel from one country to another country, they may need to manually select which country they are in, and then they can the load the selected SIM template 14, 16 04 18 for that country. After the SIM template, e.g., template 14, is loaded, the cellular telephone having the active and loaded SIM template on the SIM card will be recognized by the local carrier so that the customer can use local phone numbers stored on the SIM card to make and receive a local phone call without roaming charges and without replacing the SIM card.

A method to transfer and merge personal information stored in a multiple template SIM card from that card into a one card image requires the implementation of a software or firmware program to store several SIM templates and to load a selected SIM template.

A program running on a individual SIM card can generate the SIM template. The template not only stores SIM parameters but also a phone book, call records and SMS messages. When a user travels to other countries, he can switch his telephone service provider with the same SIM card inserted. He can also choose to save and merge the phone book, call records and SMS messages currently on the current SIM card to a SIM template. A user will then be able to carry and access the address book, call log, and SMS messages, which were previously saved in another SIM card in one location.

Users purchase a list of SIM templates on a website. When the users travel to a country, they should be able to load each of the templates on the fly to their cell phone and store it in the SIM card based on the country they select. When users receive a call or make a call, only local airtime service is used, thus eliminating international roaming charges to users. With this service available, service providers in each country can sell their prepaid local SIM cards on the website to users. Each SIM card from service providers will be converted to and saved as a SIM template. Those SIM templates should be available for users to purchase and transfer to their phones.

According to a specific embodiment of the invention, a method and system are provided whereby incoming or outgoing calls are at local rates which are much cheaper than the same calls using international roaming services. In a specific embodiment, the invention provides a method that includes a combination with the single SIM and Roaming Service. This brings tremendous savings and convenience to international travelers worldwide.

According to an embodiment of the invention, a Subcriber Identity Module (SIM) template manager system is provided. In such an embodiment, the system is built on a SIM operating system. In a specific embodiment, the SIM template manager system is capable of creating, storing, and deleting SIM templates on a SIM card. In an embodiment, the system includes methods for managing SIM data in a SIM template. An example of a SIM template has been described in U.S. Provisional Application No. 60/801,040, filed May 16, 2006, commonly assigned, and hereby incorporated by reference.

In a specific embodiment of the invention, a SIM system is provided which follows the specification ISO 7816. The protocol is the “asynchronous half duplex T=0 protocol” with “active low reset” and “inverse convention” as defined in this standard. In other embodiments, alternative protocols are included.

The present invention provides a SIM system which includes 64K, 128K or 256K EEPROM memory 200.

In a specific embodiment, the invention provides an STK SIM which includes the following features:

GSM Phase 2+ and SIM Tool-kit for developing SIM applications

Support for all three version of the COMP128 authentication algorithm

Range of SIM applications for Operators to deliver value-added-services

Special cardACS security technique—Anti-Cloning mechanism to deter fraud.

In an embodiment of the present invention, the SIM system includes the following features:
Compliant with ISO 7816-1, 7816-2, 7816-3, 7816-4
Compliant with GSM 11.11, GSM 11.14, GSM 11.17, GSM 03.40, GSM 03.48
Support for COMP 128-1, -2, -3 authentication algorithm
Special cardACS security technique—Anti-Cloning mechanism to deter fraud
Special cardDPS-II data security technique can ensure user data and prolong usage life.

In some embodiments of the invention, the SIM system provides the following optional built-in STK applications:
All IOD services
Group SMS
Multi-IMSI
Multi-Phonebook
Multi-Inbox
Dynamic Menu Manager.
Password Manager.

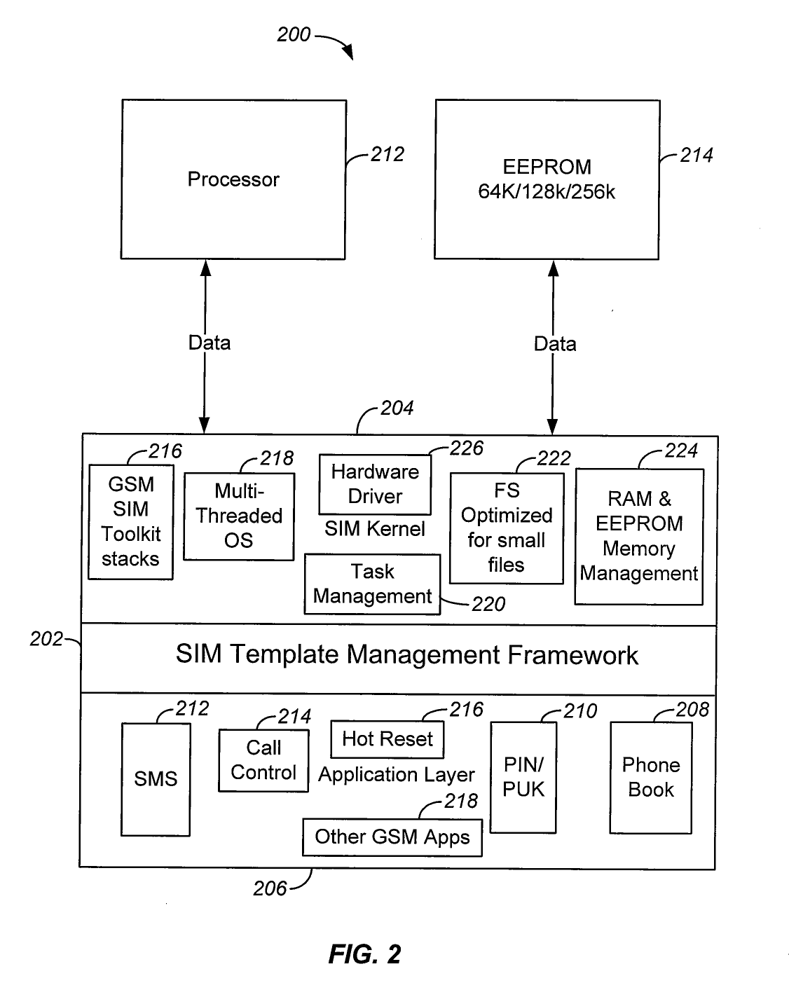

FIG. 2 is a simplified diagram for a SIM system 200 according to an embodiment of the invention. A SIM Template Management Framework 202 has a SIM kernel 204 and an application layer, with the Sim kernel 202 being coupled to a processor 212 and an EEPROM 214 of a selected size to exchange data. The SIM kernel 204 has as part of its functional content GSM SIM toolkit stacks 216, a multithreaded operating system 218, a task management element 220, a file system 222 optimized for small files, a RAM and EEPROM memory management module 224 and a hardware driver for interfacing with other components. The application layer 206 has a phone book 228, a PIN/PUK module 210, an SMS module 212, a call control module 214, a hot reset module 216 and such other GSM application modules 218 as have been defined or may be defined for this user environment.

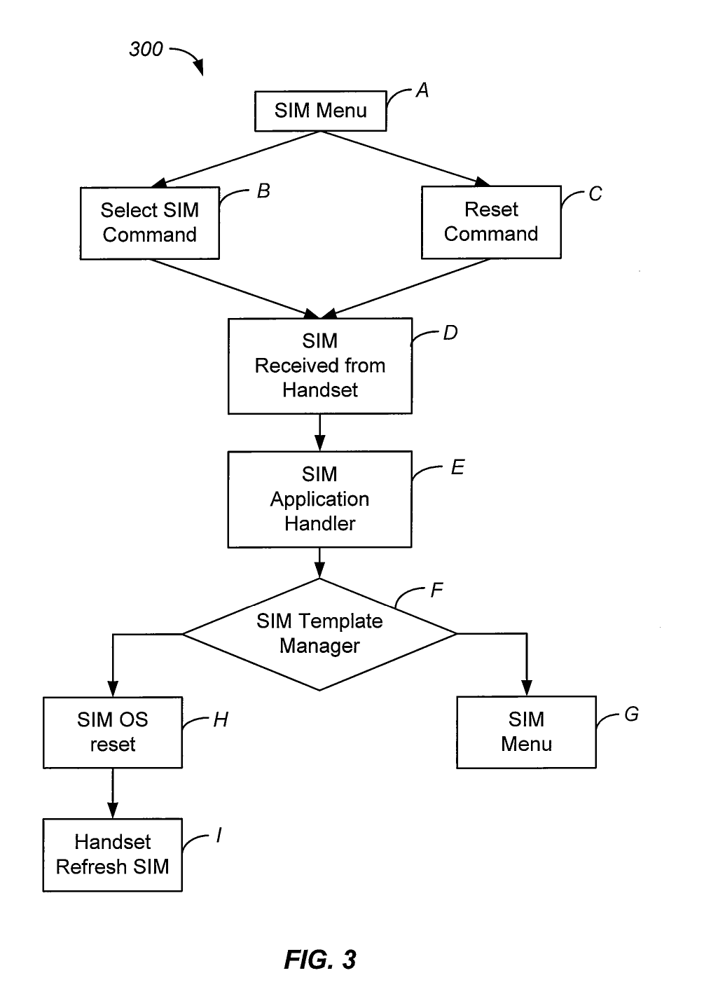

FIG. 3 is a simplified flow chart 300 for a method provided by a SIM system according to an embodiment of the invention. From a SIM menu (Step A), one can select a SIM command (Step B) or a reset command (Step C), which is received at the SIM from its handset (Step D), passed to the SIM application handler (Step E), and then acted upon by the SIM template manager (Step F), where it is either routed to a SIM menu or submenu (Step G) or causes a SIM OS reset (Step H) from which the handset refreshes the SIM (Step I).

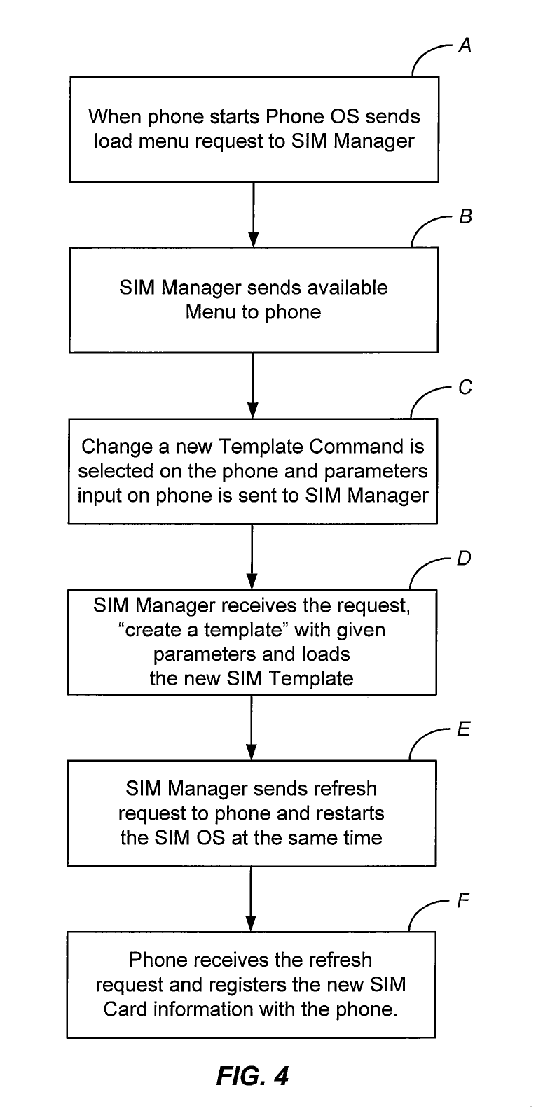

According to embodiments of the invention, the SIM stores programmed methods for writing SIM information. FIG. 4 is a simplified flow chart for a method for configuring the SIM manually from a user interface according to an embodiment of the present invention. To start, the in-phone operating system sends a “loads menu” request to the SIM manager program (Step A). The SIM manager responds by sending the available menu to the phone (for display and input) (Step B). To adopt a new template, the menu selection “Change to new template” command is selected, and the parameters for the selected template that on the phone are sent to the SIM manager, which may be a remote database. (Step C). The SIM manager receives and processes the request by creating a template with the given parameters and loads the new SIM template into the phone (remotely). (Step D) The SIM manager sends a refresh request to the phone and concurrently restarts the SIM operating system so that the new SIM template is activated. (Step E) Upon the phone receiving the refresh request, the phone registers the new SIM card information with the phone so it can be operated with the new SIM parameters (Step F).

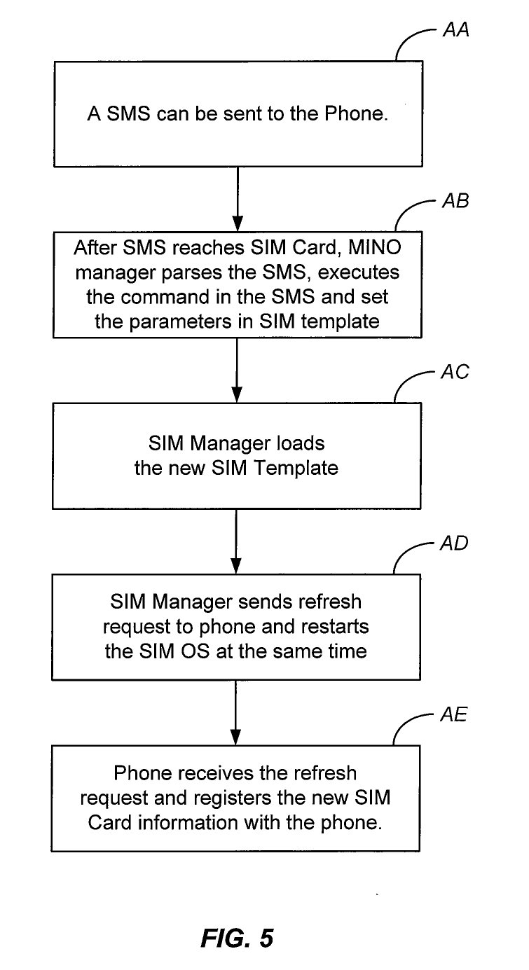

FIG. 5 is a simplified flow chart for a method for configuration of the SIM card starting from a formatted SMS message send to the phone (StepAA). In a specific embodiment, SIM Template information is saved in the SMS and parsed as two parts (Step AB). They are the Command part and the Data part. The Command part tells the SIM manager what to do. In an embodiment, the commands includes Create, Modify, and Delete. The Data part stores the actually data the Command operates on. In an embodiment, types of data include template identification, Carrier information, Call Record, Contact list, and SMS messages.

After the command is executed, the SIM manager loads the new template (Step AC), and the SIM manager sends a refresh request to the cellphone to restart the SIM operating system with the new SIM template (Step AD). Upon receiving the refresh request, the cellphone registers the new SIM card information (Step AE) and is ready to be used with the new personality.

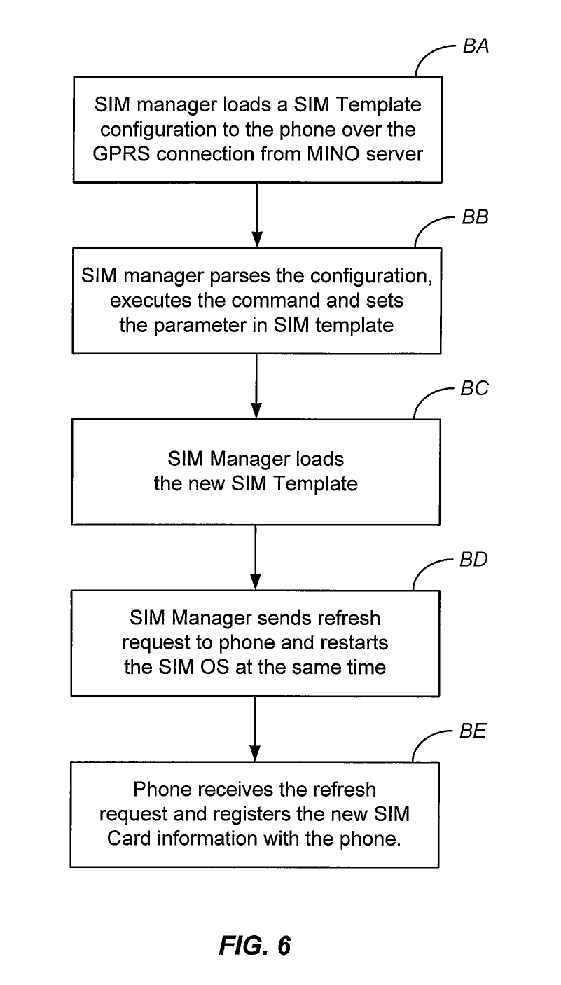

The SIM may also be configured using GPRS. Referring to FIG. 6, a simplified flow chart is shown for a method for configuration of the SIM using GPRS. In a specific embodiment, the system manager loads the SIM template configuration from the server directly to the cell phone (Step BA). The SIM manager parses the configuration, executes the command and sets the parameters in the SIM template (Step BB). In a specific embodiment, SIM Template information is encoded in two parts: Command and Data. The Command part tells SIM manager to what to do. The commands include Create, Modify, and Delete. The Data part stores the actually data the Command operates on. In a specific embodiment, types of data include template identification, Carrier information, Call Record, Contact list and SMS messages.

After the command is executed, the SIM manager loads the new template (Step BC), and the SIM manager sends a refresh request to the cellphone to restart the SIM operating system with the new SIM template (Step BD). Upon receiving the refresh request, the cellphone registers the new SIM card information (Step BE) and is ready to be used with the new personality.

The invention has been explained with reference to specific embodiments. Other embodiments will be evident to those of skill in the art. Therefore it is not intended that the invention be limited other than as indicated by the claims.

What is claimed is:

1. For use in a telecommunication system employing, a Subscriber Identity Module or SIM card for use in a telephone handset comprising:
a plurality of SIM templates for storing at least country data;
a mechanism coupled to or resident in the telephone handset for activating a selected one of the SIM templates, said selected one being a local telephone service area so that the telephone handset is not subject to roaming service.

2. A method for configuring a Subscriber Identity Module or SIM manually from a user interface on a phone having an in-phone operating system and operative with a SIM card, the method comprising:
causing in-phone operating system to send a “loads menu” request to a SIM manager program;
awaiting for the SIM manager program to send a currently available menu to the phone;
in response to manual input, selecting a new template from the menu and accepting inputted parameters for the selected template;
sending the inputted parameters to the SIM manager;
receiving from the SIM manager a template with the given parameters into the phone;
receiving from the SIM manager a refresh request into the phone; and
restarting the SIM operating system so that the new SIM template is activated; and
registering new SIM card information from the new SIM template with the phone so it can be operated with the new SIM parameters.

3. A method for enabling a Subscriber Identity Module card or SIM card on a phone having an in-phone operating system to support a selected SIM configuration so that the phone is not subject to roaming charges, the method comprising:
causing the in-phone operating system to request a remote server for a plurality of SIM templates; thereby
causing the remote server to send a message with a command and data to set parameters of the SIM templates;
causing a SIM manager to load a selected SIM template according to the command with data for designating the local area of service; and
causing the SIM manager to restart the SIM OS and refresh the phone with the selected SIM template as a virtual SIM card.

4. The method of claim 3 wherein the message is according to an SMS format.

5. The method of claim 2 wherein the message is sent via a GPRS connection.
